(19) United States
(12) Patent Application Publication
(10) Pub. No.: US 2022/0005066 A1
(43) Pub. Date: Jan. 6, 2022

(54) SYSTEM AND METHOD TO PROVIDE PRODUCT RECOMMENDATION AND SPONSORED CONTENT TO PATIENTS MANAGED BY COMPUTERIZED WORKFLOWS FOR TREATMENT PROTOCOLS

(71) Applicant: PREDICTMEDIX INC., Toronto (CA)

(72) Inventors: Rajiv Muradia, Ottawa (CA); Rahul Kushwah, Toronto (CA)

(21) Appl. No.: 17/402,578

(22) Filed: Aug. 15, 2021

Related U.S. Application Data
(63) Continuation-in-part of application No. 17/385,889, filed on Jul. 26, 2021.
Application No. 17/385,889 is a continuation-in-part of application No. 17/384,773, filed on Jul. 25, 2021.
Application No. 17/384,773 is a continuation-in-part of application No. 17/384,686, filed on Jul. 23, 2021.
(60) Provisional application No. 63/058,567, filed on Jul. 30, 2020.
(60) Provisional application No. 63/048,152, filed on Jul. 5, 2020.
(60) Provisional application No. 63/058,567, filed on Jul. 30, 2020.
(60) Provisional application No. 63/048,131, filed on Jul. 5, 2020.
(60) Provisional application No. 63/048,152, filed on Jul. 5, 2020.

(51) Int. Cl. G06Q 30/02; G06Q 30/06

(52) U.S. Cl. CPC G06Q 30/0241; G06Q 30/0631

(57) ABSTRACT

The novel invention provides for a system and a method for product recommendation and advertisement that enables a patient undergoing a patient treatment protocol for computerized data collection, and it also enables the delivery of contextually relevant advertising to the patient based on one or more diseases and according to a predetermined computerized work-flow. Additionally, the product recommendation and advertisement method and system provide for displaying sponsored advertisement of medical products based on user preferences, history, previous purchases and other similar parameters.

### RELATED APPLICATIONS

This application is related to, and claims priority to, the following:
1. Application Ser. No. 17/385,889, filed Jul. 26, 2021 which claims priority to Provisional Application Ser. No. 63/058,567, filed Jul. 30, 2020.
2. Application Ser. No. 17/384,773, filed Jul. 25, 2021 which claims priority to Provisional Application Ser. No. 63/048,152, filed Jul. 25, 2020.
3. Application Ser. No. 17/384,686, filed Jul. 23, 2021 which claims priority to:
   a. Provisional Application Ser. No. 63/058,567, filed Jul. 30, 2020.
   b. Provisional Application Ser. No. 63/048,152, filed Jul. 5, 2020.
   c. Provisional Application Ser. No. 63/048,131, filed Jul. 5, 2020.
4. Provisional Application Ser. No. 63/072,392, filed Aug. 31, 2020.

The subject matter of the related applications, each in its entirety, is expressly incorporated herein.

### BACKGROUND OF THE INVENTION

The present invention provides a novel and unique method and system for health care plans. More specifically, the invention relates to health care plans involving collection of information regarding patient's compliance with a health care plan and information regarding a patient's health as measured by maintaining key biometrics within a recommended healthy range for those biometrics and providing medical product related advertisements and product recommendations for use by the patient to speed up the recovery of the patient.

In recent years, the costs of providing high quality health care have increased to the point that, in many countries, health care costs represent a significant portion of state expenditures. In some countries, private health care companies provide health care services. In both cases increasing costs of skilled medical professionals, medical test equipment and pharmaceuticals have resulted in strong desire to find inexpensive alternatives.

With the digitization of marketing domains, it has become evident that advertisers desire highly targeted audiences. For example, Google AdSense uses the search indices of its search engine to determine which keywords are relevant to a particular page, and which pages are popular on the internet. Users searching for information using particular keywords are more desirable to some advertisers. For example, a user searching for “MP3 player” on Google is probably looking for such a device. Advertisers are willing to pay high fees to advertise on web sites which contain relevant information about MP3 players (and rank highly for the keywords “MP3 player”) because those searches filter the users of Google's search engine to only include the ones interested in and possibly purchasing an MP3 player or digital music.

Numerous products and methods are available in the market place for provisioning, testing, approving, and delivering ads to targeted users. Systems and methods are available for dynamically pricing ads (via various kinds of auctions), and of scheduling ads based on targeting as well as advertiser constraints (e.g. daily spending caps). Such marketing platforms demonstrate various ways of collecting data about ad delivery, and user-driven responses for more information (e.g. Google AdSense statistics). The advanced technology related to targeted advertisement combined with online health management system provide a unique opportunity to reach a target segment of audience that have a high probability of buying medical products.

In this context, one way to provide improved health care is to motivate patients to comply with treatment protocols and to improve their health as determined by bringing key biometrics to a healthy range. Studies show that it takes motivation, clear communication, regular direct feedback and rewards to motivate people to change their behavior. With mobile data networks, mobile computer devices and internet connectivity, it is possible to both regularly solicit vital measurements (e.g. blood pressure, weight, blood sugar, etc) as well as other relevant information from patients. Such information is easy to capture in a centralized data repository and the data can be mined for various purposes. Besides, with advent of new and efficient medical products, the patient and health care partners can collect accurate and precise information of the patient's health leading to speedy recovery and improved health.

A novel way of implementing large-scale health system is to use computer implemented methods and systems for monitoring, treatment and assessment of health conditions. This is also very relevant to patients with chronic diseases that have no definite cure but which can be managed by changing the patient's life style. Patients undergoing a computer implemented medical treatment protocol may periodically and/or frequently solicited for information such as vital measurements and questions. They may use computerized user interfaces such as web pages and mobile applications to respond to information; the collected data is captured and analyzed. A treatment may be proposed by the disease management expert/doctor, which involves procuring medical equipment/products for self-monitoring. Such patients are a desirable target market for some advertisers. For example, a patient who uses such a system to manage his diabetes is a desirable prospect for advertisers who sell diabetes-related products, exercise related products, specialized diets and other related products. It would be advantageous to have a system to deliver advertisements and recommend products and services that best fit the needs of the patients from the advertisers.

### SUMMARY OF THE INVENTION

The present application discloses systems and methods for product recommendation and advertisement that enables a patient undergoing a patient treatment protocol for computerized data collection, and it also enables the delivery of contextually relevant advertising to the patient based on one or more diseases and according to a predetermined computerized work-flow. In addition, the product recommendation and advertisement system and method may provide product evaluation and product recommendation criteria based on different parameters. Additionally, the product recommendation and advertisement method and system provide for displaying sponsored content/advertisement of medical product based on user preferences, history, previous purchases and other similar parameters. The product advertisement and recommendation systems may gather data to provide a computerized patient treatment protocol. The treatment may require a patient to buy or rent a medical product.

In some embodiments, the product advertisement and recommendation system evaluates the available medical products based on one or more parameters such as but not limited to technical specifications, functionality, reliability, performance, operational convenience, manufacturer recommendations, user experiences and other parameters associated with the medical product and/or patient.

In some embodiments, the product advertisement and recommendation may evaluate other information such as but not limited to ratings of such products and services on different websites, expert opinions, care management partner's experiences, wellness partner's experiences and such other parameters.

In some embodiments, the product advertisement and recommendation methods and systems may provide sponsored content related to medical products based on bidding information from advertisers and or patients. In an alternative implementation, the sponsored advertisements may be interspersed in between objectively analyzed medical product evaluations or criteria. In some embodiments, the sponsored advertisements nay be marked as sponsored advertisement for benefit of the patient.

In some embodiments of the present invention, the disclosed systems and methods may provide a computerized patient treatment protocol with computerized workflows to gather patient data such as vital measurements, questionnaire data, methods to use patient data, disease data, and data gathered over the treatment protocol, to characterize a patient demographically for the purposes of delivering targeted advertising.

In some embodiments, the product advertisement and recommendation systems and methods may provide a mechanism to test, approve, deliver, assure, measure and bill for contextually targeted ad delivery to patients; a method to use patient data, disease data, and data from the computerized treatment protocol to demographically characterize patients; and a computerized workflow used to gather patient data; and a method to insert sponsored/provisioned ads into the computerized workflow.

In embodiments, the product advertisement and recommendation systems and methods may characterize patients in different ways, which may be attractive to advertisers, but use an approach of characterizing patients by patient demographic data (e.g. age, gender, geographical location, etc), patient treatment protocols (e.g. obesity, diabetes, chronic kidney disease, hypertension), and patient indices to measure compliance, persistence, and success in managing the condition and improving their health. Patient indices are computed from data gathered regularly as a part of the patient treatment protocol.

In some embodiments, the product advertisement and recommendation systems and methods may implement a patient targeting mechanism to dynamically set the price, offers, trial period and approve sale. In some embodiments, the product advertisement and recommendation system may deliver ads to targeted users based on learning algorithms based on at least one of the following parameters such as medical product, patient data and patient disease.

In some embodiments, the product advertisement and recommendation system and method may be able to deliver targeted advertisements to patients who use the computerized information gathering workflow to view advertisements as they perform the steps of the workflow.

In some embodiments, the product advertisement and recommendation system and method may record every instance of an advertisement delivery and every instance that a user interacted with an advertisement to request more information about the medical product or the manufacturer of the product for machine learning and future use.

### DESCRIPTION OF FIGURES

Different embodiments will now be described in detail with reference to the drawings, in which:

FIG. 1 is a block diagram of an overview of the environment of product advertisement and recommendation management system and method in accordance with an embodiment of the present invention;

FIG. 2 illustrates different components of the product advertisement and recommendation management module in an embodiment of the present invention;

FIG. 3 illustrates the different components of a product evaluation module and a product recommendation module for providing product recommendations and sponsored content in an embodiment of the present invention;

FIG. 4 illustrates a product advertisement and recommendation management system in an embodiment of the present invention;

FIG. 5 illustrates the process flow of product advertisement and recommendation management system in an embodiment of the invention.

### DETAILED DESCRIPTION OF THE INVENTION

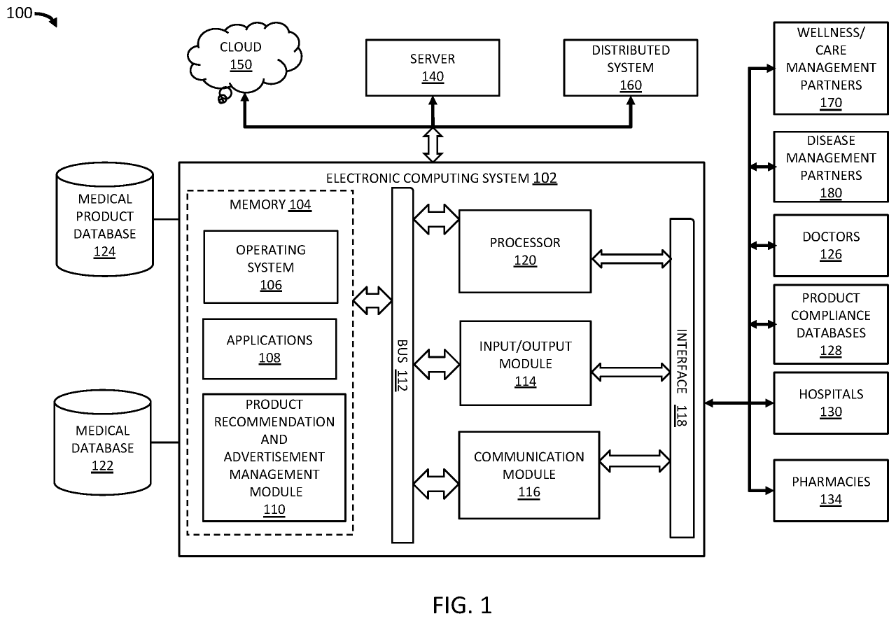

FIG. 1 illustrated the overall environment of a product recommendation and advertisement system according to some embodiment. The overall environment 100 comprises an electronic computing device 102 networked with a cloud 150, a server 140, a distributed system 160, a medical product database(s) 124, and a medical database(s) 122. The overall environment 100 for the product recommendation and advertisement system further comprises one or more wellness management partners 170, one or more disease management partners 180, one or more doctors 126, one or more product compliance databases 128, one or more hospitals 130, and one or more pharmacies 134.

The electronic computing device 102 includes a memory 104 comprising an operating system 106, one or more applications 108, and a product recommendation and advertisement module 110 interfaced with an internal bus 112 to a processor 120, one or more input/output devices 114, and one or more communication devices 116. The internal bus 120 carries data and supplies electrical current among different modules. In addition, the electronic computing device 102 includes an interface 118, which allows the electronic computing device 102 to connect with one or more wellness management partners 170, one or more disease management partners 180, one or more doctors 126, one or more product compliance databases 128, one or more hospitals 130, and one or more pharmacies 134. Additionally, the interface 118 allows the electronic computing device 102 to communicate and exchange information with the server 140, the distributed system 160 and the cloud 150 as well as one or more medical product database 124 and one or more medical database 122.

In some embodiments, the patient may own the electronic computing device 102 for managing and tracking his/her own health.

In some embodiments, the electronic computing device 102 may be a desktop computer owned by the customer and connected with the Internet.

In some embodiments, the electronic computing device 102 may be a mobile device or a medical device with a wireless connectivity and software application for product recommendation and advertisement management system 110 for managing health and provide product recommendations to the patients.

The one or more wellness management partners 170, the one or more disease management partners 180, the one or more doctors 126, the one or more hospitals 130, the one or more product compliance databases 128 and the one or more pharmacies 134 may be connected with the electronic computing device 102 of the patient via wired or wireless network, for example, the interface 112 may be implemented using a USB interface or a LAN connection using different type of ports such as micro USB, C type or some other type of interfacing hardware and software. In another example, the wireless connection may be a Bluetooth, Edge or Wi-Fi or some other type of wireless connection. In embodiments, the connection made by the electronic computing device 102 may be through a physical port or a virtual port.

The electronic computing device 102 further includes the product recommendation and advertisement module 110. The product recommendation and advertisement module 110 may reside in a single device or distributed over a network. In some embodiments, the product recommendation and advertisement module 110 may be implemented by combining various distributed modules that may reside in different devices in a networked environment such as the cloud 150, the server 140, and the distributed system 160.

The overall environment 100 further includes the medical product databases 124 and the medical database 122. The medical product database 124 stores information related to different medical products for monitoring and managing diseases. For example, the patient may use a blood pressure meter to measure the blood pressure. The information related to different medical products may include features, medical compliance data, functions, use and recommendations of the medical product. In some embodiments, the product manufacturer may provide product details to the medical product database(s) 124. In some embodiments, the product manufacturer may be required to register and authenticate the credentials before entering the product details.

The medical product database 124 may include details related to medical product manufacturer, full device traceability, stricter pre-market control, transparency, UDI and clinical evaluation, technical documentation and product registration with regulatory authorities. Additionally, the medical product database 124 may provide information related to use of the product and restriction to use a product under certain specific conditions.

The medical database 122 may include information related to patients, current products used by the patient, patient history, disease(s) from which the patent is suffering, medications that this patient is taking and other information related to the patient.

In some embodiments, the medical database 122 and the medical product database 124 may be connected to the electronic computing device 102 by a network. Alternatively, in another embodiment, the medical database 122 and the medical product database 124 may reside in the electronic computing device 102.

The one or more disease management partners 180 and/or the wellness/care management partner responsible for treatment and care of the patient may use the medical database 122 and the medical product database 124 for suggesting medical products to the patient. In addition, the one or more hospitals 130 may provide the patient with relevant information and or product specification to the patient. Furthermore, the one or more pharmacies 134 may provide product availability and recommend the medical products. In absence of proper aggregation of this information, the patient may end up getting a device based on a recommendations and/or suggestion of one the different stakeholders and purchase a medical product, which might not comply with the medical needs of the patient. Therefore, the novel product recommendation and advertisement system provides a unique method and system of suggestion the best product by performing an objective evaluation based on technical parameters.

In some embodiments, the product recommendation and advertisement method and system may directly evaluate the medical products based on machine learning algorithms and provide one or more recommendations to the patient regarding the product that best fulfills the treatment requirements.

In some embodiments, the product recommendation and advertisement method and system may provide sponsored advertisement along with product recommendation to the patient in unranked list for the patient to evaluate the medical product.

In some embodiments, the product recommendation and advertisement method and system may provide sponsored advertisement based on the highest bidder for placement of advertisement, wherein the advertisement is placed in a specified area that the advertiser recommends to the system for the patient to evaluate the medical product.

In some embodiments, the product recommendation and advertisement method and system may provide sponsored advertisement based on a monetary arrangement with the product recommendation and advertisement method and system for the patient to evaluate the medical product.

In some embodiments, the product recommendation and advertisement method and system may display a sponsored advertisement based on user preferences of the patient. The sponsored and non-sponsored medical products may be displayed based on the selection that the user sets based on user preferences.

In some embodiments, the product recommendation and advertisement method and system may display a sponsored advertisement based on user preferences of the patient. The non-sponsored medical products may be displayed based on the user requirement set by the user. The user may set different criteria for product selection based on at least one of the quality, price, compliance, functions, performance and some other parameters related to medical product.

In some embodiments, the one or more pharmacy 134 may provide medicine and/or equipment to one or more disease management partners 180/one or more care/wellness management partners 170, or a care provider. In addition, the one or more pharmacies 134 may record the experience of the medical products in the product recommendation and advertisement system.

The product recommendation and advertisement system provides medical products recommendation to enable faster recovery of the patient by ensuring compliance with the protocol prescribed by the medical expert. Furthermore, the product recommendation and advertisement system provides unbiased recommendation that is independent of human intervention. The deep learning algorithm evaluates multiple parameters associated with the product to provide recommendation to the patient based on objective and targeted recovery plan.

In some embodiments, the product recommendation and advertisement system may intelligently pitch sponsored advertisement based on at least one parameter associated with the patient's disease and the recommended product by the deep learning algorithms.

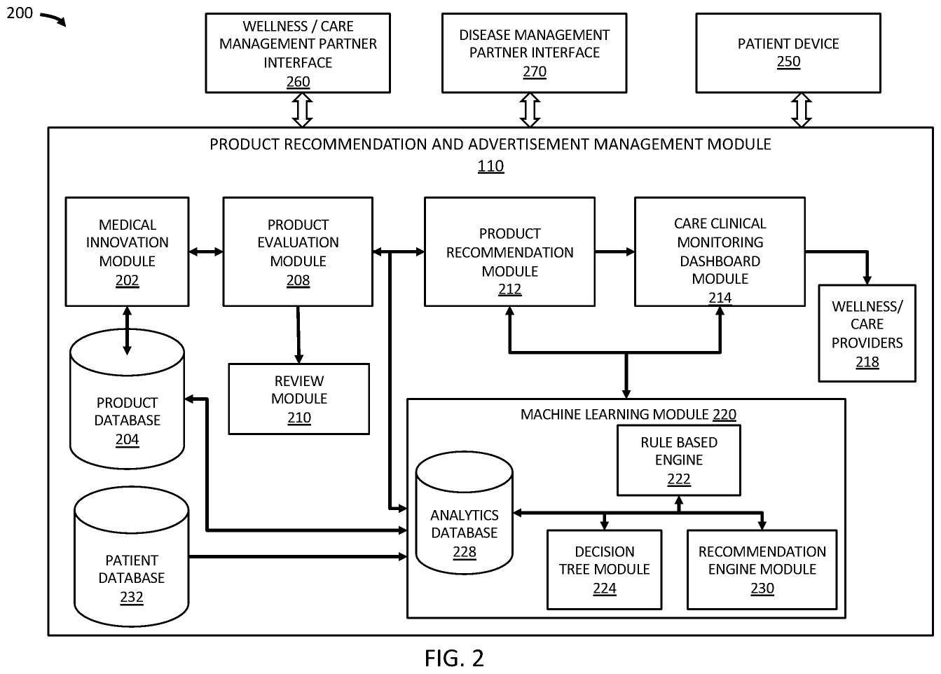

FIG. 2 illustrates different components of the product advertisement and recommendation module in an embodiment of the present invention. The product advertisement and recommendation module 110 comprises a medical innovation module 202, a product database 204, a product evaluation module 208, a review module 210 apart from other modules. The medical innovation module 202 may include a search crawler that may provide the administrator with the latest information related to product available online. In embodiments, the search may be performed on World Wide Web (WWW) or could be extracted from the subscribed or free RSS feeds or different product manufacturers may upload information related to new products. In addition, the disease management partners 180, the wellness management partner 170, the doctors 126, or the one or more pharmacies 134 may feed information through the medical innovation module 202.

The information aggregated from various sources by the medical innovation module 202 is stored in the product database 204. The product database 204 may include information about each product. For example, the product database 204 may include information related to technical specifications, functionality, compliance, make, type, certifying agency, user manual, product experience and other parameters related to the medical product.

The product recommendation and advertisement module 110 allows the different stakeholders to add, manage, search, and evaluate the medical products. The stakeholder can add products, technical specification, functionality and other product attributes. Likewise, the stakeholders can manage product offerings by updating information related to medical products. In some embodiments, the product evaluation module may extract information from the product catalog to automatically add the relevant information.

The product evaluation module 208 evaluates the medical products based on one or more parameters. In some embodiments, the evaluation may be performed based on the product attributes by ranking different product attributes based on a disease template. In embodiments, each product may be ranked differently based on a disease template. The product evaluation may store the medical products based on different disease templates. For example, a chronic disease such as Type II diabetes may rate a product X as rank one. However, the same product may occupy rank 6 for a person with Type I diabetes due to algorithm evaluation. In this example, the algorithm may take cost, functionality and product usage reliability as important parameters.

The review module 210 allows the different stakeholders such as care management partners, the wellness partners, the doctors, the hospitals, and the pharmacies to review product information related to medical products.

In some embodiments, the review module 210 may allow multiple stakeholders to review and/or provide recommendation of the medical products.

In some embodiments, the review module 210 may allow multiple stakeholders to review and/or provide recommendation to the medical products based on disease template with which they are associated.

In some embodiments, the review module 210 may allow multiple stakeholders to review and/or provide recommendation of the medical products based on request generated by the product recommendation and advertisement module 110 based on the prior history and/or the treatment protocol handled by the one or more stakeholders.

A patient database 232 stores all information related to disease(s) of the patient. The medical database includes information related to patient's medication, past history of disease(s), age, gender, clinical data and other vital parameters for medical use. In some embodiments, the medical data is aggregated from different sources such as but not limited to pharmacies, hospitals, and patient's devices.

A product recommendation module 212 evaluates different parameters related to the medical product. The product recommendation module is connected to a machine-learning module 220 and a care clinical monitoring dashboard module 214 which may be used to communicate with wellness/care providers 218.

The machine-learning module 220 may comprise a rule based engine 222 which utilizes the analytics database 228 to retrieve and store relevant information and may use a decision tree module 224 and recommendation engine module 230 to provide the input to and receive feedback from product recommendation module 212.

Product recommendation and advertising management module may connect through multiple interfaces such as wellness/care partner interface 260, disease management partner interface 270 and a patient device 250 to handle the communication between the wellness/care partner, the disease management partner and the patient in regards to the recommended medical products.

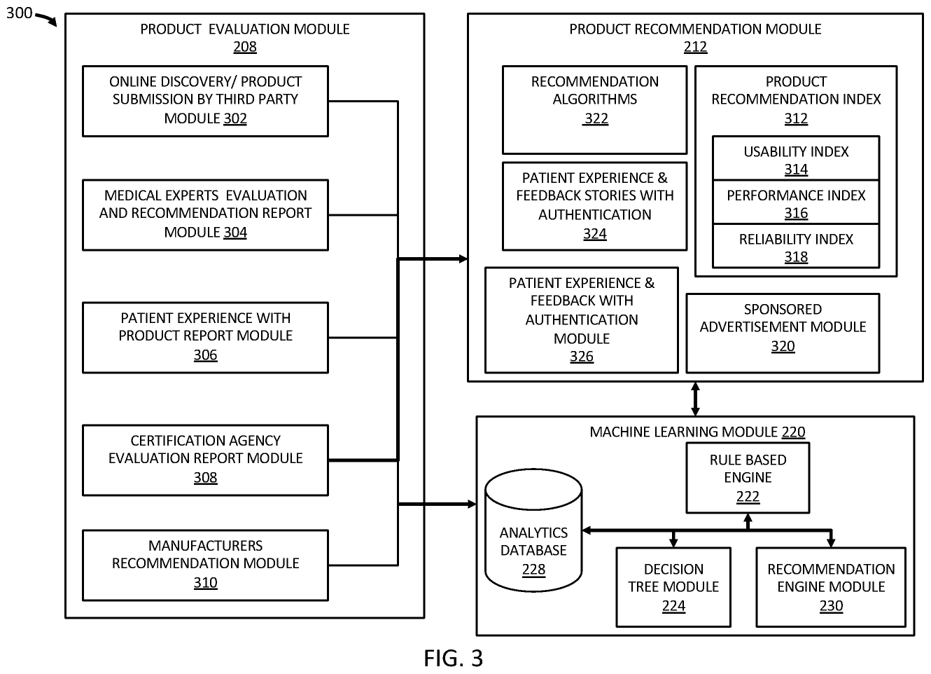

FIG. 3 illustrates different parameters for evaluation of the medical product for product recommendation and advertising in an embodiment of the present invention. The product evaluation module 208 includes an online discovery and product submission by a third party module 302. The online discovery and product submission by a thirds party module may be an independent module 302 and may use different discovery mechanisms to identify new medical products. In addition, the online discovery and product submission by a thirds party module may allow third parties to register new and innovative products to the product recommendation and advertisement module 110 for product evaluation and recommendation.

The product evaluation module 208 may designate different stakeholders to evaluate a new or an existing product and prepare a recommendation report. A medical expert evaluation and recommendation module 304 in the product evaluation module 208 may perform the method of product evaluation and provide a report regarding the usability of the medical product according to different treatment protocols/templates.

A patient experience with product report module 306 may allow the patient to share their experiences with the medical product. The experiences shared by patients can be aggregated and stored in a database and may be utilized for ranking a product.

Normally, there are certification agencies that provide product compliance and usability. A certification agency evaluation report module 308 may capture different information related to product technical parameters and its conformance for medical use. The information aggregated may be stored in a database and used for product advertising and recommendation purpose.

Finally, manufacturers may provide detailed analysis regarding the medical product capabilities and performance. A manufacturer recommendation module 310 may capture information related to functionality, performance, repeatability and other parameters of the medical product for product evaluation.

The product evaluation module 208 is connected with the machine-learning module 220 and the product recommendation module 212. The machine learning module 220 may implements algorithms for product selection and recommendation based on one or more parameters provided by the analytics database 228 such as treatment protocol, care management partners recommendation, pharmacy recommendations, patient history, patient diseases and others.

The product recommendation module 212 uses different parameters from the machine-learning module 220, for example, parameter related to patients. In addition, the product recommendation module 212 may also receive other parameters from the product evaluation module 208, for example, online discovery, patient experience, manufacturer recommendation and other parameters to produce a product recommendation index 312.

In embodiments, the parameters received from the product evaluation module 208 and the patient data received from the medical database may be stored in the analytics database 228, which can be filtered and transformed into useful information before passing the filtered information to rule based engine 222 and the recommendation engine module 230 to produce a product recommendation list.

In some embodiments, the product recommendation module 212 may include a sponsored advertisement 320 that allows the system to intersperse the medical product recommendation list with sponsored content related to medical data.

In some embodiments, the product recommendation module 212 may create a product recommendation index 312, which may include parameters such as a usability index 314, a performance index 316, a reliability index 318 and other parameters to provide details regarding assessment and for to provide greater freedom to the patient to choose the product as per their own criteria.

In some embodiments, the product recommendation module 212 may provide authenticated patient experiences of users. A patient experience & feedback with authentication module 326 provides searching and linking of authenticated recommendations received from the machine-learning module 220 along with the sponsored content. The sponsored content/advertisement is processed and/or stored in the sponsored advertisement module 320. In some embodiments, the sponsored content provider may provide the authenticated recommendations related to the product.

In some embodiments, the authentication related to past usage of the medical product by the user may be associated with the sponsored content. The sponsored content listed in the product recommendation list may include links, images, and texts related to recommendation.

In some embodiments, the product recommendation provided by different users may be aggregated to prepare a table showing parameters such as usability index 314, performance index 316, reliability index 318 and other similar parameters for benefit of the patient.

Referring back to FIG. 2 and FIG. 1, a care clinical monitoring dashboard module 214 is provided for different stakeholders such as the disease management partners 180, the wellness/care management partners 170, the doctors 126, the hospitals 130, the pharmacies 134 to provide product recommendation and/or share reviews and other feedback regarding the medical product. In some embodiments, the care management partner interface 260 and the disease management partner interface 270 may be used for sharing product recommendations, feedback, and other reviews related to product feedback. In some embodiments, the patient may provide recommendations related to the medical product by sharing or acknowledging recommendation and or providing specific feedback for the medical device that the patient has used or the medical device that is currently in use.

In some embodiments, the product advertisement and recommendation management module 110 may automatically insert advertisements based on machine learning algorithms. The automatic selection may be based on user-preferences, previous purchases, patient disease condition, previous registered devices, and patient's affinity with the care management partner. In this case, the learning algorithm may make the selection based on specific purchasing behavior of the patient in the past.

In some embodiments, the product advertisement and recommendation management module 110 may automatically insert advertisements based on the critical illness of the patient and requirements of patients with such illness that may be available to the product advertisement and recommendation management module 110 through the patient database 232.

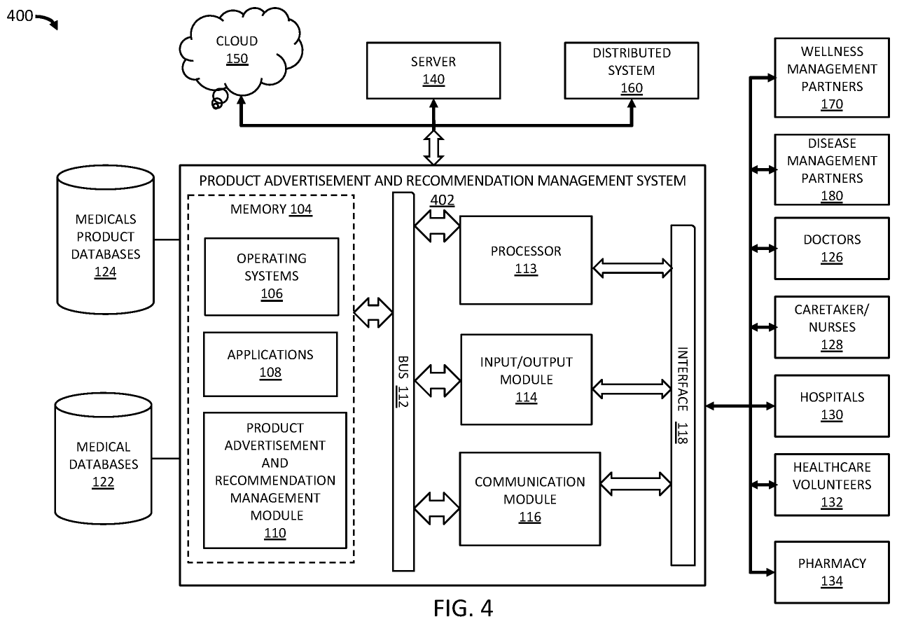

FIG. 4 illustrates a product advertisement and recommendation management system 402 in an embodiment of the present invention. The product advertisement and recommendation management system 402 may be a standalone system for managing the product recommendation and/or sponsored content based on multiple parameters derived from the medical database 122 comprising patient data and medical product database 124 comprising product related information. In addition, the product advertisement and recommendation management system 402 may provide sponsored content based on sponsorship provided by medical product partners. In some embodiments, the product advertisement and recommendation management system 402 may be a dedicated server which may centrally control all the processes, activities, tasks and manage product recommendations based on at least patient data.

In some embodiments, the product advertisement and recommendation management system 402 may receive monetary and non-monetary rewards from the medical product-sponsoring partner for sponsored content.

In some embodiments, the product advertisement and recommendation management system 402 may provide an option of selecting either the recommended products or the sponsored content or both the recommended products and the sponsored content.

In some embodiments, the product advertisement and recommendation management system 402 may implement deep learning algorithm to select the criteria for product recommendation based on patient data such as patient disease, patient demographics, patient preferences, past purchase history of the patient and other such parameters.

The product advertisement and recommendation management system 402 comprises the memory 104 comprising the operating system 106, the one or more applications 108, and the product advertisement and recommendation management module 110 interfaced with the internal bus 112 to the processor 113, the one or more input/output devices 114, and the one or more communication devices 116. The internal bus 112 carries data and supplies electrical current among different modules. In addition, the product advertisement and recommendation management system 402 comprises the interface bus 118, which allows the product advertisement and recommendation management system 402 to connect with the cloud 150, the server 140 and the distributed system 160. In addition, the medical database 122, the medical product database 124 can be accessed by the product advertisement and recommendation management system 402 through the internal bus 112 and the interface 118.

The product advertisement and recommendation management system 402 may connect with one or more wellness management partners 170, one or more disease management partners 180, one or more doctors 126, one or more caretakers/nurses 128, one or more health care volunteers 132, one or more hospitals 130, and one or more pharmacies 134.

The product advertisement and recommendation management system 402 comprises the product advertisement and recommendation management module 110, which performs the function of recommending medical products to the patient based on one or more parameters as discussed above.

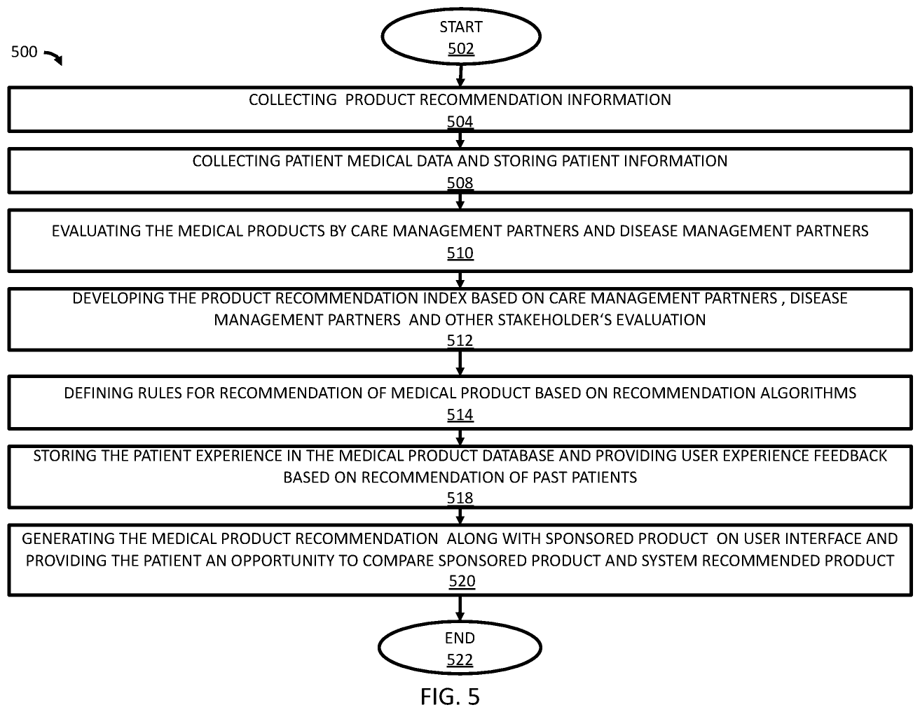

Referring to FIG. 5, the process of product recommendation and sponsored content is illustrated in an embodiment of the present invention. The process starts at 502 and immediately proceeds to the step 504. At step 504, a patient may interact with the product advertisement and recommendation management method and system to provide product recommendation for the medical product by sharing a review or by providing a feedback to an online questionnaire or by sharing the experience in form of a structured feedback. In addition, a process associated with the patient stores persistent data about patient behavior, preferences and browsing history to identify parameters such as patient's brand affinity, type of products, etc. Furthermore, the authenticated recommendation are utilized for providing feedback along with the sponsored content and further used as a parameter for calculating the product recommendation index. At step 508, the patient medical history may be collected from multiple sources such as but not limited to patient database, hospitals, pharmacies, doctors and other medical sources such as clinical laboratories, patient devices, and other sources. If the patient is already registered, the patient may initiate a process of entering the medical record related to disease(s) from which the patient is suffering. Once the patient enters the history, the process 508 stores all information related to the patient in the medical database. In some embodiments, the patient data may also be stored in the medical database 122 or the analytics database 228.

At step 510, the process 500 create different templates for evaluation by different stakeholders such as care management partners, the wellness partners, the doctors, the hospitals, and the pharmacies to review product information related to medical products. Each stakeholder may provide feedback related to the medical product by filling one or more evaluation templates. In embodiments, in addition to the stakeholder evaluation, the process at step 510 may collect information by searching World Wide Web for medical products; the process 500 may also collect information through third party submissions. In some embodiments, the product compliance databases may be searched to record the feedback related to the medical product. Additionally, manufacturer or sponsored content providers feedback may be collected and stored in the product database 204.

In some embodiments, a group of medical experts may create the disease template rather than just one medical expert in cases where the patient has multiple diseases and may provide recommendations of the medical products along with those disease templates according to their understanding which may be the best under those circumstances. Alternatively, the patient may request for a specific medical expert based on the patient's prior experience. At step 512, the process 500 may develop a product recommendation index based on the feedback collected from different sources, for example, the feedback collected from the product evaluation module 208, the patient database 232, and the sponsored advertisement module 320.

In some embodiments, the product recommendation module 212 may insert sponsored content based on the feedback received from the machine learning module 220 automatically based on evaluation of one or more variables. For example, the sponsored content/advertisement relevance, patient's preferences, patient data comprising of patient disease, patient past experience, patent influencers such as care management or disease management partner and other such parameters.

In some embodiments, product recommendation may be made by using deep learning algorithms and different parameters related to the patient, received feedback, and sponsor partner contributions and relevance.

At step 514, the process 500 may calculate rules for evaluation and recommendation of the medical products. In addition, the process 500 may also create the rules for insertion of sponsored content based on criteria defined by the content sponsoring partners and relevance index of the medical product as evaluated by the sponsored content partner.

In some embodiments, the evaluation plan may be developed by experts in consultation with different partners, which may be passed on to the machine learning algorithm for training purposes and the machine learning algorithm may train itself to automate the process of creating evaluation and recommendation methodology for the medical products based on one or more parameters. In such embodiment, the evaluation and recommendation methodology may be developed using machine learning algorithms based on rules stored in the analytics database.

At step 518, the process 500 may monitor and track the different parameters related to patient preference for medical products and save the intrinsic knowledge about the medical product selection and recommendation behavior. For example, the process 500 may track all recommendation of the medical products made by a specific patient, scan browsing history, scan patient's affinity with specific stakeholders, scan specific patient demographic and disease(s) of the patient and store this information in the database.

At step 520, the process 500 may generate the medical product recommendation along with sponsored content and may display it on the patient's/user's interface. In some embodiments, the sponsored content may be inserted in the recommended product based on parameters provided by the sponsor content partner in association with the evaluation performed by the machine learning algorithms. The process 500 terminates at step 522.

A product advertisement and recommendation system for a patient undergoing treatment protocol, the product advertisement and recommendation system comprising a data collector configured to a patient database, a product database and an analytics database; a product evaluation module having a product evaluation criterion and configured to a review interface wherein a health stakeholder may provide a product recommendation and feedback to create product evaluation information; a product recommendation module implementing product recommendation algorithms based on a set of parameters to create product recommendation information; a machine learning module configured to the product evaluation module and the product recommendation module to analyze the product evaluation information and the product recommendation information to recommend a medical product for a patient, and a patient device for displaying the recommended medical product to the patient along with patient care information.

In embodiments, the product database may store information related to medical products and may be configured to a plurality of sources, wherein at least one of the plurality of sources may provide product recommendation. In embodiments, the patient database may comprise of information related to patients. In addition, the patients' information may comprise medical and disease information of the patients.

In embodiments, the analytics database may include rules for associating the patient information and the medical product information using deep learning algorithms based on one or more parameters.

In embodiments, the medical product database may utilize search crawlers to capture product recommendation and other feedback related to medical products and may extract information that can be utilized by the machine-learning module for product recommendation and advertising.

In embodiments, the product database may store medical product information and may be configured to a plurality of sources, wherein at least one of the plurality of sources provides product recommendation.

In embodiments, the patient database may store medical and disease information of patients.

In embodiments, the analytics database may comprise a set of rules to associate medical and disease information of patients and medical products information by using deep learning algorithms based on a set of parameters.

In embodiments, the medical product database may further comprise a search crawler to capture a product recommendation and feedback of medical products and extract relevant information to be utilized by the machine learning module for product recommendation and advertising.

A computer implemented product advertisement and recommendation method for a patient undergoing treatment protocol, the product advertisement and recommendation method comprising: receiving data from a patient database, a product database and an analytics database; aggregating a set of medical product recommendations received from a set of stakeholders through a review interface; evaluating a medical product using a set of product evaluation criteria based on a set of parameters, wherein the set of parameters relate to the medical product, the set of medical product recommendations and a patient's disease to create a product evaluation information; running a product recommendation algorithm based on the set of parameters, to create a product recommendation information; implementing machine learning algorithm to analyze the product evaluation information and the product recommendation information to create a product recommendation index; recommending a medical product based on the product recommendation index; and displaying the recommended medical product to the patient along with patient care information.

In embodiments, the product recommendation index may comprise a product usability index, a product performance index, and a product usability index.

In embodiments, the product evaluation criteria may comprise a combination of online product evaluation discovery, medical expert's evaluation and recommendation reports, patient experience reports, certification agency reports, and manufacturer recommendation reports.

In embodiments, the stakeholders may comprise a combination of care partners, doctors, caretakers, disease management partners, hospitals, and pharmacies.

In embodiments, the set of parameters may comprise a combination of patient age, patient history, patient disease management templates, and patient treatment protocols.

In embodiments, the machine learning algorithm may be configured to a rule based module and an analytics database and may determine a placement of sponsored content based on a set of user preferences and patient's browsing history.

We claim:

1. A product advertisement and recommendation system for a patient undergoing treatment protocol, the product advertisement and recommendation system comprising:
a data collector configured to a patient database, a product database and an analytics database;
a product evaluation module having a product evaluation criterion and configured to a review interface wherein a health stakeholder may provide a product recommendation and feedback to create a product evaluation information;
a product recommendation module implementing a product recommendation algorithm based on a set of parameters to create a product recommendation information;
a machine learning module configured to the product evaluation module and the product recommendation module to analyze the product evaluation information and the product recommendation information to recommend a medical product for a patient, and
a patient device for displaying the recommended medical product to the patient along with patient care information.

2. A product advertisement and recommendation system of claim 1, wherein the product database stores a medical product information and is configured to a plurality of sources, wherein at least one of the plurality of sources provide product recommendation.

3. A product advertisement and recommendation system of claim 1, wherein the patient database stores medical and disease information of patients.

4. A product advertisement and recommendation system of claim 1, wherein the analytics database comprises a set of rules to associate a medical and disease information of a patient and a medical product information by using deep learning algorithms based on a set of parameters.

5. A product advertisement and recommendation system of claim 1, wherein the medical product database further comprises a search crawler to capture a product recommendation and feedback of a medical product and extract a set of relevant information to be utilized by the machine learning module for product recommendation and advertising.

6. A computer implemented product advertisement and recommendation method for a patient undergoing treatment protocol, the product advertisement and recommendation method comprising:
receiving data from a patient database, a product database and an analytics database;
aggregating a set of medical product recommendations received from a set of stakeholders through a review interface;
evaluating a medical product using a set of product evaluation criteria based on a set of parameters, wherein the set of parameters relate to the medical product, the set of medical product recommendations and a patient's disease to create a product evaluation information;
running a product recommendation algorithm based on the set of parameters, to create a product recommendation information;
implementing machine learning algorithm to analyze the product evaluation information and the product recommendation information to create a product recommendation index;
recommending a medical product based on the product recommendation index; and
displaying the recommended medical product to the patient along with patient care information.

7. The computer implemented method of claim 6, wherein the product recommendation index comprises a product usability index, a product performance index, and a product usability index.

8. The computer implemented method of claim 6, wherein the product evaluation criteria comprises a combination of an online product evaluation discovery, a medical expert evaluation and recommendation report, a patient experience report, a certification agency report, and a manufacturer recommendation report.

9. The computer implemented method of claim 6, wherein the stakeholders comprise a combination of a care partner, a doctor, a caretaker, a disease management partner, a hospital, and a pharmacy.

10. The computer implemented method of claim 6, wherein the set of parameters comprise a combination of patient age, a patient history, a patient disease management template, and a patient treatment protocol.

11. The computer implemented method of claim 6, wherein the machine learning algorithm is configured to a rule based module and an analytics database and determines a placement of sponsored content based on a set of user preferences and patient's browsing history.
